(19) United States
(12) Patent Application Publication
(10) Pub. No.: US 2022/0097753 A1
(43) Pub. Date: Mar. 31, 2022

(54) Steer-By-Wire Steering System

(71) Applicant: Joyson Safety Systems Germany GmbH, Aschaffenburg (DE)

(72) Inventors: Dieter Markfort, Berlin (DE); Philipp WERDIN, Berlin (DE)

(21) Appl. No.: 17/483,056

(22) Filed: Sep. 23, 2021

(30) Foreign Application Priority Data
Sep. 25, 2020 (DE) 10 2020 212 121.4
Nov. 4, 2020 (DE) 10 2020 129 080.2
Mar. 15, 2021 (DE) 10 2021 202 509.9

(51) Int. Cl. B62D 5/00; B62D 5/04

(52) U.S. Cl. CPC B62D 5/006; B62D 5/0463

(57) ABSTRACT

It is provided a steer-by-wire steering system with a steering handle which can be rotated about a rotational axis, and with a restoring torque generator which is assigned to the steering handle) for the generation of a torque which is directed counter to a rotation of the steering handle about the rotational axis. Furthermore, the steer-by-wire steering system comprises at least one elastic element, via which the restoring torque generator is supported on a supporting element which is fixed to the vehicle. The at least one elastic element has a higher stiffness in a first direction parallel to the rotational axis than in a second direction which runs substantially perpendicularly with respect to the rotational axis and, in particular, tangentially with respect to an imaginary rotational body, the axis of rotation of which coincides with the rotational axis.

### REFERENCE TO RELATED APPLICATION

This application claims priority to German Patent Application No. 10 2020 212 121.4 filed on Sep. 25, 2020, to German Patent Application No. 10 2020 129 080.2 filed on Nov. 4, 2020 and to German Patent Application No. 10 2021 202 509.9 filed on Mar. 15, 2021, the entirety of which is incorporated by reference herein.

### BACKGROUND

The solution relates to a steer-by-wire steering system.

A steering system of this type comprises a steering handle which can be rotated about a rotational axis. A vehicle driver can input a desired steering angle via the steering handle. In the case of a steer-by-wire steering system, however, the vehicle wheels are decoupled mechanically from the steering handle. Therefore, a restoring torque generator serves to generate or to set a self-aligning torque which counteracts a torque which is generated by way of the vehicle driver via the steering handle. In the case of a steer-by-wire steering system, the steering angle which is input by the vehicle driver via the steering handle is transferred exclusively in an electric way to actuating assemblies or actuators for steering the vehicle wheels. In this context, it is necessary for the torque of the steering handle to be determined.

For this purpose, it is known for the torque of the steering handle to be converted into an angle which can be measured, by means of a torsion spring with a known torsion stiffness, via which torsion spring the steering handle or the restoring torque generator is supported on a vehicle structure. As a result of friction, torque disruptions can occur here. In order to avoid them, the torsion spring can be mounted via plain bearings or anti-friction bearings. Anti-friction bearings tend to wear rapidly in the case of small oscillating rotational movements, however, and can generate great torques in the case of subsequent greater movements, whereas plain bearings as a rule have breakaway torques.

### SUMMARY

The object underlying the proposed solution consists in the production of a support of a steering handle for a steer-by-wire steering system, which support avoids the mentioned disadvantages and makes a detection of the torques which act in the case of operation of the steer-by-wire steering system possible.

This object is solved by way of the provision of the steer-by-wire steering system with features as described herein.

In accordance with this, the steer-by-wire steering system first of all comprises a steering handle which can be rotated about a rotational axis. The steering handle can be configured, for example, as a steering wheel. Furthermore, the steer-by-wire steering system comprises a restoring torque generator which is assigned to the steering handle for the generation of a torque which is directed counter to a rotation of the steering handle about the rotational axis. The restoring torque generator can comprise a housing, a drive which is arranged in a stationary manner in the housing, a transmission which is in engagement with the drive, and a shaft which is mounted in the housing and is connected fixedly to a component of the transmission for conjoint rotation. The shaft can likewise be rotated about a rotational axis, the rotational axis of the shaft coinciding, in particular, with the rotational axis of the steering handle. The restoring torque generator can be, in particular, one of the restoring torque generators which are described in WO 2020/127204 A1.

Moreover, the steer-by-wire steering system comprises at least one elastic element, via which the restoring torque generator is supported on a supporting element which is fixed to the vehicle. In particular, the restoring torque generator is supported via the at least one elastic element on the supporting element which is fixed to the vehicle, counter to a rotation about the rotational axis of the steering handle. Here, the support in relation to the supporting element which is fixed to the vehicle can take place, in particular, via the housing or the shaft of the restoring torque generator. On account of the elasticity of the at least one elastic element, the restoring torque generator can be moved with respect to the supporting element which is fixed to the vehicle, whereas it is supported on the supporting element which is fixed to the vehicle.

The steer-by-wire steering system is characterized in that the at least one elastic element has a higher stiffness along a first direction parallel to the rotational axis of the shaft or of the steering handle than along a direction which runs substantially perpendicularly with respect to the said rotational axis and with respect to the first direction. In addition, the second direction runs, in particular, tangentially with respect to an imaginary rotational body, the axis of rotation of which coincides with the rotational axis.

The term “stiffness” is to be understood to mean the resistance with which the at least one elastic element counteracts its elastic deformation in the case of the introduction of a force or a torque into the at least one elastic element. Along the first direction, the force is introduced into the at least one elastic element predominantly by way of the vehicle driver (by way of a tilting movement of the restoring torque generator about an axis which runs substantially perpendicularly with respect to the rotational axis). Along the second direction, the force is introduced into the at least one elastic element by way of a rotational movement of the restoring torque generator about the rotational axis, that is to say firstly by way of the vehicle driver (in the case of actuation of the steering handle) and secondly by way of the restoring torque generator.

Here, the stiffness of the at least one elastic element can also be so high along the first direction that an elastic deformation of the at least one elastic element along the first direction is virtually or completely impossible below a defined force level. Here, the stiffness along the first direction can be considerably higher than along the second direction.

On account of the direction-dependent stiffness of the at least one elastic element, a defined elasticity of the at least one elastic element is produced in the rotational direction about the rotational axis (second direction) in the case of a simultaneously very high stiffness of the at least one elastic element (and therefore of the steering system) in the tilting direction (first direction) about an axis which is directed substantially perpendicularly with respect to the rotational axis. It can therefore additionally be provided that the restoring torque generator is connected solely via the at least one elastic element to the supporting element which is fixed to the vehicle, whereas, in particular, the restoring torque generator does not have any connection to another element which is fixed to the vehicle.

In accordance with one embodiment, the restoring torque generator comprises a housing, a drive which is arranged in a stationary manner in the housing or with regard to the housing, a transmission which is in engagement with the drive, and a shaft which is mounted in the housing and is connected fixedly to a component of the transmission for conjoint rotation. Here, the shaft or the housing is configured for a fixed connection to the steering handle for conjoint rotation. Here, in contrast, the housing, the transmission and the shaft are configured for mounting which can be rotated (in relation to the supporting element which is fixed to the vehicle (motor vehicle) and about a rotational axis of the shaft). In particular, the at least one elastic element can be fastened firstly to the supporting element which is fixed to the vehicle and secondly to the restoring torque generator. For the case where the housing is configured for a fixed connection to the steering handle for conjoint rotation, the at least one elastic element can be connected by way of a first end fixedly to the shaft, in particular to an end of the shaft which faces away from the steering handle, for conjoint rotation, and can be fastened by way of a second end to the supporting element which is fixed to the vehicle. For the case where the shaft is configured for a fixed connection to the steering handle for conjoint rotation, the at least one elastic element can be connected by way of its first end fixedly to the housing for conjoint rotation, and can be fastened by way of its second end to the supporting element which is fixed to the vehicle. In the unloaded state of the at least one elastic element, that is to say without the action of an external force, the first and the second end of the at least one elastic element can lie on an axis which extends along a third direction, the third direction being directed in each case perpendicularly with respect to the first and to the second direction. Accordingly, the third direction runs substantially perpendicularly and radially with respect to the rotational axis.

Furthermore, it is conceivable that a plurality of elastic elements are provided. The elastic elements can be identical in terms of shape and size. The elastic elements can be arranged in different ways.

For instance, the elastic elements can be arranged in such a way that they define a plane which extends perpendicularly with respect to the rotational axis. That is to say that the elastic elements are arranged at the same height in relation to the rotational axis. Here, the elastic elements can also have an extent along the rotational axis (along the first direction). Two adjacent elastic elements can enclose an angle in the plane (which they define). The elastic elements can be distributed uniformly about the rotational axis, with the result that the angle between two adjacent elastic elements is in each case of equal magnitude. For example, the number of elastic elements can be four, and the angle between two adjacent elastic elements can be 90°. The number of elastic elements in one plane can be selected in accordance with the requirements, but should be at least three.

As an alternative, the elastic elements can be arranged offset along the rotational axis and can extend in each case in a plane which lies perpendicularly with respect to the rotational axis. The planes are parallel to one another. Here, the elastic elements can likewise be offset with respect to one another in a projection area perpendicularly with respect to the rotational axis, with the result that, in the projection area, each elastic element has, for example, a different orientation (radial orientation) with regard to the rotational axis.

In accordance with a further alternative, the elastic elements can be arranged in a plurality of planes which extend in each case perpendicularly with respect to the rotational axis, a plurality of elastic elements being arranged in at least one of the plurality of planes. Here too, the elastic elements which are not arranged in the same plane (which extends perpendicularly with respect rotational axis) can have different radial orientations with regard to the rotational axis.

In accordance with a further embodiment, the elastic elements have different dimensions. Here, the elastic elements can differ from one another, in particular, in relation to their radial extent with respect to the rotational axis.

Furthermore, it is conceivable that the at least one elastic element comprises a flat element which extends in one plane. Here, the at least one elastic element can be arranged in such a way that the rotational axis of the steering handle or of the shaft of the restoring torque generator lies in the plane of the elastic element. For example, the at least one elastic element can be configured as a leaf spring.

In accordance with one embodiment, the at least one elastic element has a greater extent along the first direction (in the direction parallel to the rotational axis) than along the second direction (in the direction which runs substantially perpendicularly with respect to the rotational axis and, in particular, tangentially with respect to the imaginary rotational body, the axis of rotation of which coincides with the rotational axis). Furthermore, (in the unloaded state of the at least one elastic element) the extent of the at least one elastic element can be greater along the third direction (in the direction which runs substantially perpendicularly and radially with respect to the rotational axis) than along the second direction. Here, the extent of the at least one elastic element can be greater along the third direction than along the first direction.

The steering system can comprise at least one sensor which is configured for the detection of a force and/or for the detection of an angle of the rotation about the rotational axis of the shaft. The steering system can comprise, in particular, a plurality of sensors, of which at least one first sensor is configured for the detection of a force and at least one second sensor is configured for the detection of an angle of the rotation about the rotational axis of the shaft. The support of the restoring torque generator on the supporting element which is fixed to the vehicle (counter to a rotation about the rotational axis of the shaft) can take place with the at least one sensor connected in between. Here, the at least one elastic element can be integrated into the at least one sensor for the detection of the force.

Furthermore, it is conceivable for the at least one elastic element to be of non-linear design with regard to the deformation behaviour, with the result that the measuring accuracy of the at least one sensor is range-dependent. For instance, the range about the zero position (unloaded state of the at least one elastic element) might be of more accurate design, whereas the accuracy decreases as the rotary angle increases. The measuring range can thus be extended.

It is also possible that the elastic elements of one plane or in the planes differ from one another in terms of their deformation behaviour and their dimensions.

In accordance with one embodiment, the at least one elastic element (in its unloaded state) has a greater extent along the first direction (in the direction parallel to the rotational axis) than along the third direction (in the direction which runs substantially perpendicularly and radially with respect to the rotational axis). At the same time, the extent of the at least one elastic element (in its unloaded state) can be greater along the first direction than along the second direction (in the direction which runs substantially perpendicularly with respect to the rotational axis and, in particular, tangentially with respect to the imaginary rotational body, the axis of rotation of which coincides with the rotational axis).

A further embodiment provides that, as viewed radially with respect to the rotational axis, the at least one elastic element is arranged between firstly a section of the restoring torque generator, which section extends parallel to the rotational axis, and secondly a section, which extends parallel to the rotational axis, of the supporting element which is fixed to the vehicle or of an element which is connected fixedly to the supporting element which is fixed to the vehicle. The section of the restoring torque generator can be, for example, a section of the shaft, whereas the section of the supporting element which is fixed to the vehicle or of the element which is connected fixedly to the said supporting element is formed by way of a section of a bearing bush which serves for mounting of the shaft. Here, the shaft can be arranged at least in sections within the bearing bush, with the result that, as viewed in the radial direction with respect to the rotational axis, the bearing bush is arranged on the outside and the shaft is arranged on the inside. In particular, the bearing bush can be configured as a separate element which is connected fixedly to the supporting element which is fixed to the vehicle, and therefore forms one unit with the said supporting element. As an alternative, the section of the restoring torque generator can be configured by way of a section of the shaft which is configured as a hollow shaft, whereas the section of the supporting element which is fixed to the vehicle or of the element which is connected fixedly to the said supporting element is formed by way of a section of a bearing pin which is mounted in the hollow shaft. As viewed in the radial direction with respect to the rotational axis, the hollow shaft is therefore arranged on the outside and the bearing pin is arranged on the inside. The bearing pin can also be configured as a separate element which is connected fixedly to the supporting element which is fixed to the vehicle, and therefore forms one unit with the said supporting element.

In order to secure the at least one elastic element between the mentioned sections, the sections can have receptacles. For instance, the section of the restoring torque generator can have at least one first receptacle, and the section of the supporting element which is fixed to the vehicle or of the element which is connected fixedly to the said supporting element can have at least one second receptacle. The receptacles can be configured by way of recesses in the sections. Here, the receptacles can have, at least in sections, a shape which is complementary with respect to the shape of the at least one elastic element.

In accordance with one embodiment, the steer-by-wire steering system comprises a plurality of elastic elements which are preferably arranged uniformly around the rotational axis. Here, the elastic elements can be identical with regard to their shape, size and elastic properties. Here, each of the plurality of elastic elements can comprise a spring roller. The spring roller has, in particular, an elongate tubular shape which extends along the rotational axis. Furthermore, the spring roller has a (continuous) slot which extends along the rotational axis. A continuous slot is to be understood to mean a slot which extends over the entire extent of the spring roller along its longitudinal axis. As an alternative, the slot can extend only over a section of the spring roller, only the said section of the spring roller preferably being arranged, however, between the section of the restoring torque generator and the section of the supporting element which is fixed to the vehicle or of the element which is connected fixedly to the said supporting element. The spring roller can be produced by way of rolling up of a material section (which is, for example, metallic). The deformation behaviour of the spring roller can be defined via the material thickness of the material section and the slot width (in each case in relation to the provided diameter of the spring roller).

The number of first receptacles and the number of second receptacles can be identical and, in particular, can correspond to the number of elastic elements. For instance, in each case one first receptacle can be assigned to one second receptacle, with the result that they can together receive an elastic element. Here, the first receptacle and the second receptacle can be arranged radially in relation to the rotational axis.

The spring rollers delimit a cavity. The said cavity can serve to receive a filling element. The filling element can be, for example, rod-shaped and can be manufactured from an elastic material such as, for example, rubber. At least one groove can be made in the surface of the filling element, which grooves extends along the longitudinal axis of the filling element (and therefore along the rotational axis), in order, via the shape of the filling element, to increase its elastic properties beyond the elastic properties which are inherent to the material. It can be provided that only some or all of the spring rollers are filled with the filling element. The filling element can also be provided instead of the spring rollers, and can independently form an elastic element.

In accordance with a further embodiment, only one elastic element is provided. The elastic element can comprise a multi-spring which extends virtually completely about the rotational axis in the circumferential direction and has a (continuous) slot which extends along the rotational axis. The above comments with respect to the slot of the spring roller apply correspondingly to the slot of the multi-spring. In particular, the multi-spring is shaped in such a way that its spacing from the rotational axis increases and decreases in the radial direction in an alternating manner. The multi-spring can thus extend, as viewed in a section perpendicularly with respect to the rotational axis, in a first approximation along a circular path (the centre of which is the rotational axis), the circular path being superimposed by a periodic function. The multi-spring can thus configure, for example, an undulating or zigzag profile which follows the circular path. The number of periods can be selected in any desired manner (greater than one), and can be six, for example.

The number of first receptacles and the number of second receptacles can also be identical in conjunction with the multi-spring. In particular, the number of first and second receptacles can correspond to the number of periods of the multi-spring. Here, the first and second receptacles can be arranged offset with respect to one another in the circumferential direction and in an alternating manner around the rotational axis. Between adjacent (as viewed in the circumferential direction) first receptacles, the section of the restoring torque generator can in each case have a first projection which, in relation to the rotational axis, lies radially opposite a second receptacle (configured in the section of the supporting element which is fixed to the vehicle or of the element which is connected fixedly to the said supporting element). The section of the supporting element which is fixed to the vehicle or of the element which is connected fixedly to the said supporting element can likewise in each case have a second projection between adjacent (as viewed in the circumferential direction) second receptacles, which second projection lies radially opposite a first receptacle in relation to the rotational axis.

The shape of the first receptacles can be complementary with respect to the shape of those sections of the multi-spring which are received by the first receptacles. The shape of the second receptacles can likewise be complementary with respect to the shape of those sections of the multi-spring which are received by the second receptacles. It is preferably provided, however, that the shape of a first (second) receptacle and of that section of the multi-spring which is received therein is at least partially not complementary with respect to the shape of the second (first) projection which lies opposite it in the radial direction of the rotational axis. As a result, intermediate spaces can be produced periodically between the multi-spring and the first and/or second projections. Here, the intermediate spaces between the multi-spring and the first projections and the intermediate spaces between the multi-spring and the second projections can differ from one another in terms of their shape.

Some or all of the said intermediate spaces can be filled with a filling element. As described in conjunction with the spring roller, the filling element can be, for example, rod-shaped, and can be manufactured from an elastic material. The filling element can have the properties of the filling element described in conjunction with the spring roller.

A further embodiment of the steer-by-wire steering system provides that the at least one elastic element is an integral constituent part of the restoring torque generator and/or of the supporting element which is fixed to the vehicle. A part of the restoring torque generator and/or of the supporting element which is fixed to the vehicle itself therefore forms the at least one elastic element.

Here, the restoring torque generator can comprise a shaft, and the supporting element which is fixed to the vehicle can comprise a bearing bush, the bearing bush being provided and being configured for mounting of the shaft. A section of the shaft and/or a section of the bearing bush can thus form the at least one elastic element.

In order to impart the required elastic properties to the section of the shaft or of the bearing bush, there are several possibilities. For instance, that section of the shaft which forms the at least one elastic element can be configured as a hollow shaft which has a specific cross-sectional shape transversely with respect to the rotational axis. For instance, the cross-sectional shape can differ from a rotationally symmetrical (in relation to the rotational axis) shape, with the result that the cross-sectional shape permits an elastic deformation of the section of the shaft in the case of the application of a torque to the shaft. The cross-sectional shape can have, for example, indentations which are directed transversely with respect to the rotational axis. On account of its function, the bearing bush is already configured as a hollow body. The bearing bush can also have the cross-sectional shape, described in conjunction with the hollow shaft, transversely with respect to the rotational axis.

A further possibility to design the section of the shaft and/or of the bearing bush to be correspondingly elastic can be achieved by way of one or more regions with a reduced material thickness. For example, the section of the shaft and/or the section of the bearing bush which forms the at least one elastic element can have at least one region of this type. The term “reduced material thickness” is to be understood to mean a local decrease of the material thickness, it even being possible for the material thickness to be decreased as far as zero (no material), that is to say the section of the shaft and/or of the bearing bush is provided partially with apertures.

The shaft and the bearing bush can be connected to one another. The connection can be configured as a latching connection. This allows a simple installation of the pre-assembled steer-by-wire steering system into a vehicle.

### BRIEF DESCRIPTION OF THE DRAWINGS

The solution is described in greater detail in the following text on the basis of exemplary embodiments with reference to the figures.

FIG. 1 shows a steer-by-wire steering system in accordance with one embodiment with an arrangement of elastic elements in accordance with one embodiment.

FIG. 2 shows a top view of the arrangement of elastic elements of the steer-by-wire steering system from FIG. 1 in the unloaded state.

FIG. 3 shows a top view of the arrangement of elastic elements of the steer-by-wire steering system from FIG. 1 in a loaded state.

FIG. 4 shows an arrangement of elastic elements in accordance with a further embodiment.

FIG. 5 shows an arrangement of elastic elements in accordance with a further embodiment.

FIG. 6 shows a steer-by-wire steering system in accordance with a further embodiment.

FIG. 7 shows a steer-by-wire steering system in accordance with a further embodiment with an arrangement of elastic elements in accordance with a further embodiment.

FIG. 8 shows a sectional illustration through the steer-by-wire steering system from FIG. 7 along the rotational axis D in the region of the elastic elements.

FIG. 9 shows an exploded illustration of the steer-by-wire steering system from FIG. 7 in the region of the elastic elements.

FIG. 10 shows a diagrammatic illustration of an elastic element in the form of a spring roller which is used in the embodiment of FIGS. 7 to 9 and 11.

FIG. 11 shows a sectional illustration through the steer-by-wire steering system from FIG. 7 perpendicularly with respect to the rotational axis D in the region of the elastic elements.

FIGS. 12-14 show sectional illustrations through a steer-by-wire steering system in accordance with further embodiments perpendicularly with respect to the rotational axis D in the region of the elastic elements.

FIG. 15 shows a diagrammatic illustration of an elastic element in the form of a multi-spring which is used in the embodiment of FIG. 13.

FIG. 16 shows a detailed view of the sectional illustration from FIG. 13.

FIG. 17 shows a steer-by-wire steering system in accordance with a further embodiment.

FIG. 18 shows an exploded illustration of the steer-by-wire steering system from FIG. 17 in the region of the elastic elements.

FIG. 19 shows a sectional illustration through the steer-by-wire steering system from FIG. 17 perpendicularly with respect to the rotational axis D in the region of the elastic elements.

FIG. 20 shows a shaft and a bearing bush for a steer-by-wire steering system in accordance with a further embodiment.

FIG. 21 shows the bearing bush of the embodiment from FIG. 20.

FIG. 22 shows a shaft and a bearing bush for a steer-by-wire steering system in accordance with a further embodiment.

### DETAILED DESCRIPTION

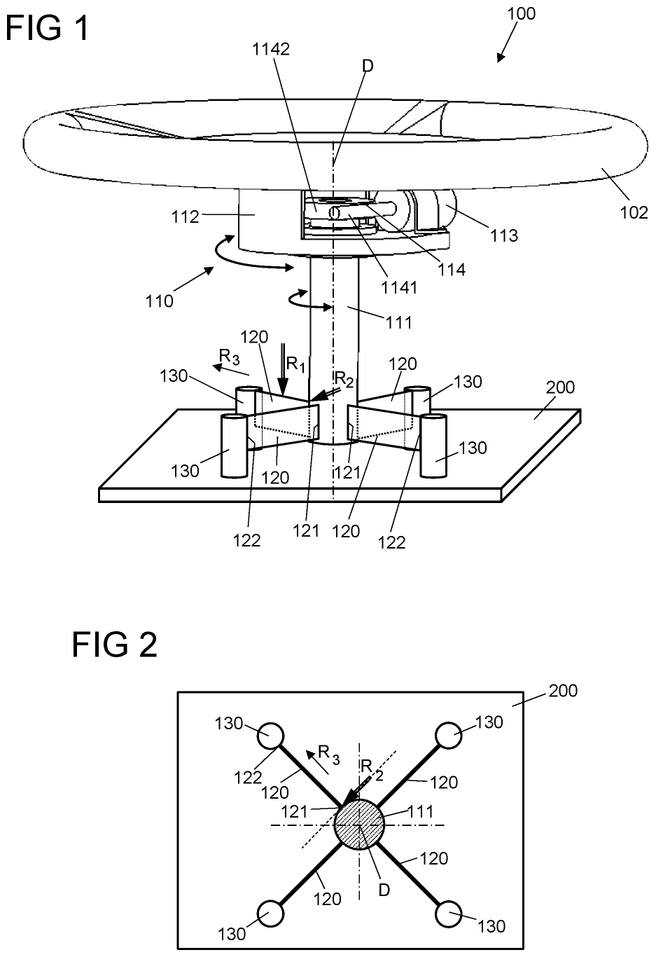

FIG. 1 shows, in a diagrammatic and exemplary manner, a steer-by-wire steering system 100 in accordance with one embodiment together with a supporting element 200 which is fixed to the vehicle and on which the steer-by-wire steering system 100 is mounted.

The steer-by-wire steering system 100 comprises a steering handle 102. In the example which is shown, the steering handle 102 is configured as a steering wheel. Furthermore, the steer-by-wire steering system 100 comprises a restoring torque generator 110. The steering handle 102 is connected fixedly to a housing 112 for conjoint rotation, which housing 112 is in turn part of the restoring torque generator 110 of the steering apparatus 100.

Moreover, the restoring torque generator 110 comprises a shaft 111 which is mounted rotatably in the housing 112. In addition, a drive 113 is provided in the housing 112, which drive 113 is arranged in a stationary manner in relation to the housing 112. Furthermore, a transmission 114 is provided between the drive 113 and the shaft 111, which transmission 114 is in engagement with the drive 113 and transmits a force which is generated by the drive 113 as a torque to the shaft 111. In FIG. 1, the transmission 114 is configured by way of example as a worm gear mechanism which comprises a worm shaft 1141 on the drive side and a worm gear 1142 on the output side. The worm gear 1142 is connected fixedly to the shaft 111 for conjoint rotation.

A steering movement (rotation of the steering handle 102 about the rotational axis D) which is exerted, for example, by a driver on the steering handle 102 is transmitted here via the housing 112, the drive 113 and the transmission 114 to the shaft 111. A torque which is generated by the drive 113 acts, on account of the fixed connection between the housing 112 and the steering handle 102 for conjoint rotation, via the housing 112 on the steering handle 102.

The shaft 111 (and, with it, the restoring torque generator 110) is mounted rotatably with respect to the supporting element 200 which is fixed to the vehicle, the said shaft 111 being supported via four elastic elements 120 on the supporting element 200 which is fixed to the vehicle. At least one of the four elastic elements 120 can be part of a force sensor which is configured for the detection of a force which is exerted on the shaft 111 (and therefore of a rotary angle of the shaft 111 about its rotational axis D). A steering torque which is exerted by a driver on the steering handle 102 can thus be determined, and the drive 113 can be actuated on the basis of the determined steering torque in such a way that a suitable self-aligning torque is generated which counteracts the steering torque.

The elastic elements 120 are identical in terms of shape and size. The elastic elements 120 are arranged at a first end of the shaft 111 and are connected fixedly to the shaft 111 for conjoint rotation. The first end of the shaft 111 lies opposite a second end of the shaft 111, on which second end the housing 112 and the steering handle 102 are arranged. Here, the elastic elements 120 are arranged substantially at the same height, in relation to the rotational axis D of the shaft 111, and additionally distributed at uniform spacings around the shaft 111. Here, two adjacent elastic elements 120 in each case enclose an angle of 90° in a plane perpendicularly with respect to the rotational axis D. The main direction of extent of the elastic elements 120 is directed in each case radially transversely with respect to the rotational axis D of the shaft 111 (FIG. 2), in the unloaded state of the elastic elements 120 (without action of an external force). In this arrangement, each elastic element 120 has a higher stiffness along a first direction R₁ (parallel to the rotational axis D of the shaft 111) than along a second direction R₂ (perpendicularly with respect to the rotational axis D and, in the connecting region between the shaft 111 and the elastic element 120, tangentially with respect to the shell face of the shaft 111). Here, the second direction R₂ is dependent on the orientation of the respective elastic element 120 in a plane perpendicularly with respect to the rotational axis D.

The direction-dependent stiffness of the elastic elements 120 can be ascribed to their shape and relative arrangement with respect to the shaft 111. Thus, in the unloaded state, the extent of each elastic element 120 is greater along the first direction R₁ than along the respective second direction R₂. Furthermore, the extent of each elastic element 120 is greater along a third direction R₃ (perpendicularly and radially with respect to the rotational axis D of the shaft 111) than along the first direction R₁ and the respective second direction R₂. The third direction R₃ is also dependent on the orientation of the respective elastic element 120 in a plane perpendicularly with respect to the rotational axis D. The described direction-dependent stiffness of the elastic elements 120 produces a defined elasticity of the elastic elements 120 in the rotational direction about the rotational axis D in the case of a simultaneously very high stiffness of the steering system 100 in the tilting direction about an axis which is directed substantially perpendicularly with respect to the rotational axis D. An additional shaft bearing system can be dispensed with as a result of the high stiffness in the tilting direction.

The elastic elements 120 have a flat extent (along the first direction R₁ and the third direction R₃) and are configured, in particular, in each case as a leaf spring.

Each elastic element 120 is fastened by way of a first end 121 fixedly to the shaft 111 for conjoint rotation. By way of a second end 122 which lies opposite the first end 121, each elastic element 120 is fastened via a corresponding fixing 130 to the supporting element 200 which is fixed to the vehicle. The shaft 111 does not have a direct connection to the supporting element 200 which is fixed to the vehicle, or to another supporting element which is fixed to the vehicle. Additional bearings are not present. The restoring torque generator 110 is supported solely by way of the elastic elements 120 with respect to the vehicle structure.

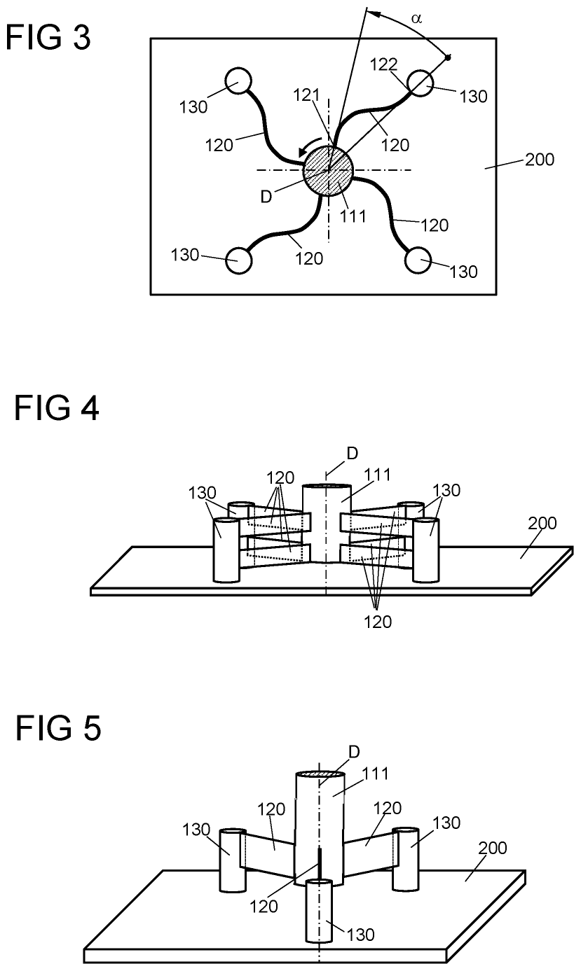

FIG. 3 shows the arrangement of elastic elements 120 from FIG. 2 in a loaded state which is brought about, for example, by way of a torque which is introduced into the elastic elements 120 via the shaft 111 counter to the clockwise direction. The resulting angle of twist α (angle between a limb on which the first end 121 of an elastic element 120 lies and a limb on which the second end 122 of the elastic element 120 lies, with the rotational axis D as angle vertex) is shown on an exaggeratedly large scale in FIG. 3 for the purpose of illustration. The angle of twist α actually lies in a range between −5° and +5° with respect to the starting position in the unloaded position. Stops can be provided in order to limit the angle of twist α. The torque of the steering handle 102 can be determined from the rotary angle α and via the flexural stiffness of the elastic elements 120 in the rotational direction (about the rotational axis D).

FIG. 4 shows an arrangement of elastic elements 120 in accordance with a further embodiment, which arrangement can be provided for the steer-by-wire steering system 100 from FIG. 1 instead of the elastic elements 120 which are shown there. The arrangement of elastic elements 120 from FIG. 4 comprises two arrangements of elastic elements 120 from FIG. 1, the two arrangements from FIG. 1 being arranged behind one another along the rotational axis D. The arrangement from FIG. 4 accordingly comprises eight elastic elements 120 which, in relation to the rotational axis D of the shaft 111, are arranged at two different heights or in two planes which are oriented parallel to one another and in each case perpendicularly with respect to the rotational axis D of the shaft 111. Here, the number (here, four) of elastic elements 120 is identical in the two planes. In addition to the number, the radial orientation of the elastic elements 120 is also identical in the two planes, with the result that, as viewed along the rotational axis D, two elastic elements 120 are always arranged behind one another. Here, the two elastic elements 120 which are arranged behind one another are fastened in each case via the same fixing 130 to the supporting element 200 which is fixed to the vehicle. A spacing is provided in each case along the rotational axis D between two elastic elements 120 which are arranged behind one another. By means of the spacing (along the rotational axis D) of the elastic elements 120 in a plurality of planes (perpendicularly with respect to the rotational axis D), the support of the restoring torque generator 110 can be improved with respect to the supporting element 200 which is fixed to the vehicle, with a simultaneous reduction of the extent of the elastic elements 120 along the first direction R₁. The arrangement of elastic elements 120 in a plurality of (here, two) planes serves to improve the stiffness of the steering system 100 in the tilting direction about an axis which is directed substantially perpendicularly with respect to the rotational axis D. In FIG. 4, the dimensions of the elastic elements 120 are identical. The dimensions can also be different, however. The number and the orientation of the elastic elements 120 can also be different in the planes.

FIG. 5 shows an arrangement of elastic elements 120 in accordance with a further embodiment, which arrangement can be provided for the steer-by-wire steering system 100 from FIG. 1 instead of the elastic elements 120 which are shown there. The arrangement from FIG. 5 differs from that in FIG. 1, in particular, in that it is not four, but rather three elastic elements 120 which are provided. The three elastic elements 120 are arranged at the same height in relation to the rotational axis D of the shaft 111. Here, two adjacent elastic elements 120 in each case enclose an angle of 120°. Otherwise, what was stated in relation to the arrangement of elastic elements 120 also applies correspondingly to this arrangement of elastic elements 120. In an analogous manner with respect to FIG. 4, the arrangement of elastic elements 120 from FIG. 5 can also be doubled, it being possible for the two arrangements from FIG. 5 to then be arranged behind one another along the rotational axis D.

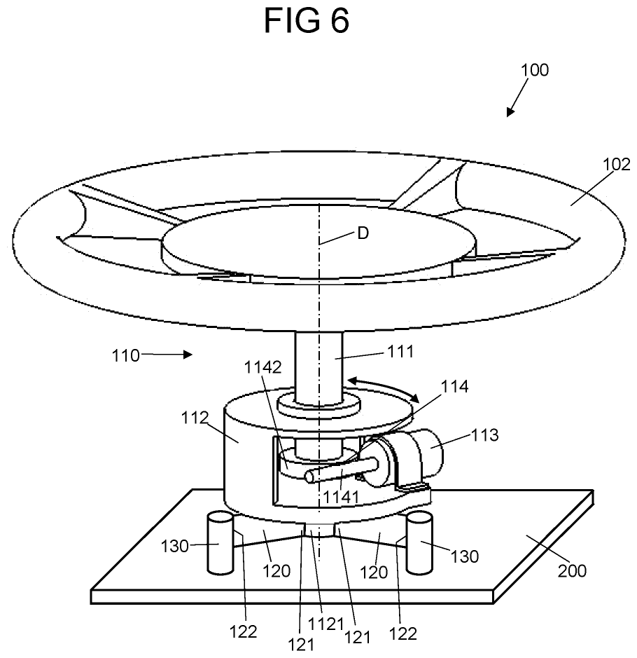

FIG. 6 shows a steer-by-wire steering system 100 in accordance with a further embodiment. Unless something different arises from the following text, what was stated in relation to the steer-by-wire system 100 from FIG. 1 also applies correspondingly to this steer-by-wire steering system 100. The embodiment from FIG. 6 differs from that from FIG. 1, in particular, in that support of the restoring torque generator 110 with respect to the supporting element 200 which is fixed to the vehicle (with respect to a rotation about the rotational axis D) does not take place via the shaft 111, but rather via the housing 112. Furthermore, the steering handle 102 is connected fixedly to the shaft 111 for conjoint rotation. This construction allows a torque which is generated by the drive 113 and the transmission 114 to be transmitted to the shaft 111, with the result that the shaft 111 rotates with respect to the housing 112 and about its rotational axis D. In addition, a torque of this type is transmitted to the steering handle 102 by way of the fixed connection of the steering handle 102 to the shaft 111 for conjoint rotation. In contrast, a steering movement which is exerted, for example, by a driver on the steering handle 102 is transmitted via the shaft 111, the transmission 114 and the drive 113 to the housing 112.

The elastic elements 120 are connected in each case at their first end 121 fixedly to the housing 112 for conjoint rotation, in particular to a shaft butt 1121 which is fastened fixedly to the housing 112 for conjoint rotation. By way of their second end 122, the elastic elements 120 are fastened via the fixings 130 to the supporting element 200 which is fixed to the vehicle. The arrangement of the elastic elements 120 corresponds to that from FIG. 1. The alternative arrangements, described in relation to the steer-by-wire steering system 100 from FIG. 1, of elastic elements 120 (FIGS. 4 and 5) can correspondingly also be applied to the steer-by-wire steering system 100 from FIG. 6.

The housing 112 does not have a direct connection to the supporting element 200 which is fixed to the vehicle, or to another supporting element which is fixed to the vehicle. Additional bearings are not present. The restoring torque generator 110 is supported solely by way of the elastic elements 120 with respect to the vehicle structure.

The description up to now of the solution has been made on the basis of a plurality of radially arranged elastic elements which are distributed on one or more planes. It is also conceivable, however, that the functionalities and the deformation behaviour of the elastic elements of one plane are depicted in a single elastic element. It is essential for the solution that, during driving operation, predominantly only an introduced torque leads to a deformation of the elastic element, and the latter is as far as possible dimensionally stable with respect to other loads.

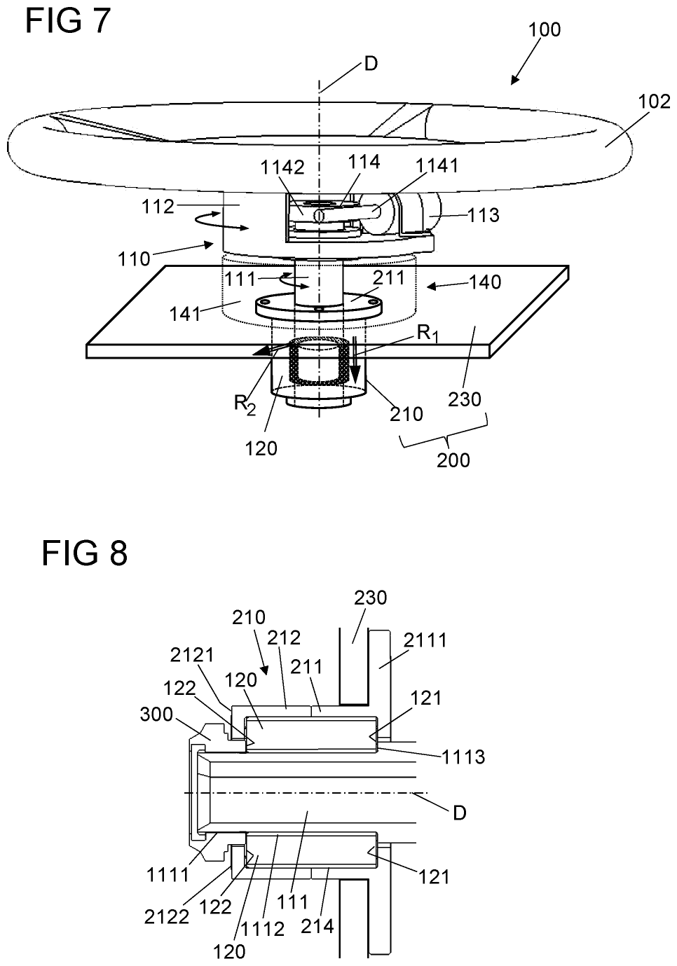

FIG. 7 shows a steer-by-wire steering system 100 in accordance with a further embodiment. As in the embodiment from FIG. 1, the restoring torque generator 110 also has a housing 112 here which is connected fixedly to the steering handle 102 for conjoint rotation, and a shaft 111 which is supported by elastic elements 120 on the supporting element 200 which is fixed to the vehicle. Unless something different arises from the following text, what was stated in relation to the steer-by-wire system 100 from FIG. 1 also applies correspondingly to this steer-by-wire steering system 100. The embodiment from FIG. 7 differs from that from FIG. 1, in particular, in terms of the configuration and the arrangement of the elastic elements 120. The elastic elements 120 are thus arranged between the shaft 111 and a section 210 of the supporting element 200 which is fixed to the vehicle, which section 210 extends parallel to the rotational axis D and surrounds the shaft 111. Here, the shaft 111 forms a section of the restoring torque generator 110, which section likewise extends parallel to the rotational axis D. In this embodiment, that section 210 of the supporting element 200 which is fixed to the vehicle, which section 210 extends parallel to the rotational axis D, is formed by way of a bearing bush 210 which serves to receive the shaft 111, as is shown in FIG. 8. The bearing bush 210 has a flange 2111 which is supported on a carrier 230 of the supporting element 200 which is fixed to the vehicle, and is connected fixedly to the said supporting element 200. Therefore, the bearing bush 210 is part of the supporting element 200 which is fixed to the vehicle. In the present case, the bearing bush 210 assumes the function of the fixings 130 which are provided in the embodiment of FIG. 1.

A further housing 141 which surrounds the shaft 111 is arranged between the housing 112 of the restoring torque generator 110 and the supporting element 200 which is fixed to the vehicle. The said housing 141 accommodates an assembly 140 for the detection of a steering movement or of a rotation of the shaft 111. The assembly 140 is configured, in particular, for the detection of a rotary angle or of a torque of the shaft 111. The assembly 140 can be, in particular, one of the sensors which are described in WO 2020/127204 A1 (to which reference is made expressly) for the detection of a force and/or for the detection of an angle of the rotation about the rotational axis of the shaft. The housing 141 can contain further assemblies which are provided, for example, for the electric or signal connection between the steering apparatus 100 and components which are fixed to the vehicle. The housing 141 can also contain electronic control units (ECUs) for controlling functions of the steering apparatus 100.

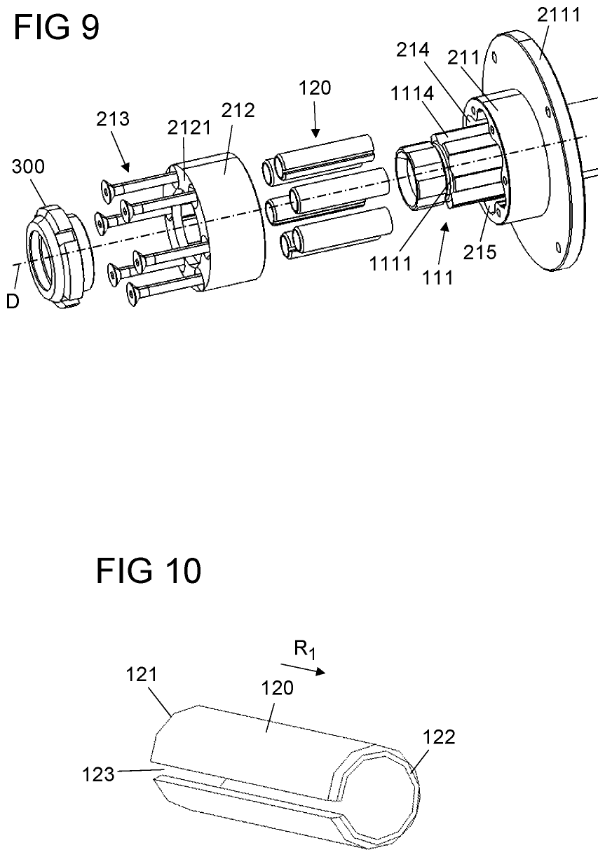

FIG. 8 shows a section through the steer-by-wire steering system 100 of FIG. 7 along the rotational axis D in the region of the bearing bush 210 and the elastic elements 120. The bearing bush 210 comprises a first part 211 and a second part 212 which are connected to one another by means of fastening elements 213 which are provided uniformly around the rotational axis D. In FIG. 9 which shows the arrangement from FIG. 8 in an exploded illustration, the fastening elements 213 are configured by way of example as screws. The first part 211 and the second part 212 of the bearing bush 210 extend behind one another, as viewed along the rotational axis D. The flange 2111 which serves to fasten the bearing bush 210 to the carrier 230 of the supporting element 200 which is fixed to the vehicle is assigned to the first part 211. The flange 2111 has a leadthrough opening for the shaft 111.

The elastic elements 120 are configured as spring rollers. A spring roller is shown by way of example in FIG. 10 in a perspective view. A spring roller 120 is a rolled-up material section (in particular, a sheet metal section) of a defined material thickness, which material section configures a cylindrical shape which is open between the axial ends. Here, the shell face of the cylinder is interrupted by way of a slot 123 which runs parallel to the longitudinal extent of the spring roller 120 and to the rotational axis D. Here, the slot 123 extends over the entire extent of the spring roller 120 between its first end 121 which faces the first part 211 of the bearing bush 210, and its second end 122 which faces the second part 212 of the bearing bush 210. In FIG. 10, the slot 123 is of rectilinear shape and is directed parallel to the rotational axis. In a deviation from the illustration in FIG. 10, the slot can also run at an angle with respect to the rotational axis D, a predominant directional component being parallel to the rotational axis D, however, with the result that the spring roller has the desired elastic properties in the case of action of a force which is directed transversely with respect to the rotational axis D.

The spring rollers 120 extend in each case longitudinally, parallel to the rotational axis D (first direction R₁), and are distributed uniformly around the rotational axis D. They have a substantially higher stiffness in the first direction R₁ than in a direction perpendicularly with respect thereto (second and third direction R₂ and R₃). This is to be ascribed to the mounting and the greater extent of the spring rollers 120 along the first direction R₁ and the slot 123 which is directed (predominantly) along the said direction.

The spring rollers 120 are not connected fixedly to the bearing bush 210 and the shaft 111. The spring rollers 120 are mounted merely in an annular gap between the bearing bush 210 and the shaft 111. In particular, the spring rollers 120 are arranged distributed along a section of an outer shell face 1112 of the shaft 111 and a section of an inner shell face 214 of the bearing bush 210. Here, the spring rollers 120 already bear in the unloaded state with a defined prestress against the bearing bush 210 and the shaft 111 at contact points or along contact lines.

As shown in FIG. 9, in its outer shell face 1112, the shaft 111 has groove-shaped recesses which form first receptacles 1114 for the spring rollers 120 and run parallel to the rotational axis D, and the first part 211 of the bearing bush 210 has, in its inner shell face 214, groove-shaped recesses which form second receptacles 215 for the spring rollers 120 and likewise run parallel to the rotational axis D. The second part 212 of the bearing bush 210 likewise has second receptacles 215 which, in the assembled state, lie in alignment with the receptacles 215 of the first part 211. The groove-shaped recesses of the shaft 111 run as far as into a threaded attachment 1111 (described further below) of the shaft 111. Starting from the rotational axis Din the radial direction, the first receptacles 1114 and the second receptacles 215 in each case lie opposite one another. The spring rollers 120 are positioned in the groove-shaped recesses of the outer shell face 1112 of the shaft 111, and engage into the corresponding groove-shaped recesses of the inner shell face 214 of the first part 211 of the bearing bush 210. The spring rollers 120 are thus secured against a linear movement transversely with respect to the rotational axis D.

The spring rollers 120 are secured axially with respect to the bearing bush 210 by way of a section of the flange 2111 of the bearing bush 210 (first end 121 of the spring rollers 120) and by way of an attachment 2122 (second end 122 of the spring rollers 120) which is directed transversely with respect to the rotational axis D at the free axial end 2121 of the second part 212 of the bearing bush 210.

The shaft 111 has a sudden change in the diameter (which forms a stop 1113 for the first end 121 of the spring rollers 120). Together with the spring rollers 120, the said stop 1113 prevents a movement of the shaft 111 with respect to the bearing bush 210 along the rotational axis D away from the steering handle 102. At its outer end which faces away from the steering handle 102, the shaft 111 is provided with the abovementioned threaded attachment 1111. The latter protrudes partially beyond the free axial end 2121 of the bearing bush 210. Via a nut 300 which is in engagement with the threaded attachment 1111, extends radially beyond the shaft 111, and thus forms a possible bearing face for the free axial end 2121 of the second part 212 of the bearing bush 210 and/or for the elastic elements 120, a movement of the shaft 111 with respect to the bearing bush 210 along the rotational axis D in the direction of the steering handle 102 is prevented in the case of exceeding of a limit load. Via the elastic elements 120 which are configured as spring rollers, the bearing bush 210 is connected to the shaft 111 in such a way that the shaft 111 can be rotated with regard to the bearing bush 210, but a movement in the direction of the rotational axis D is prevented as far as possible.

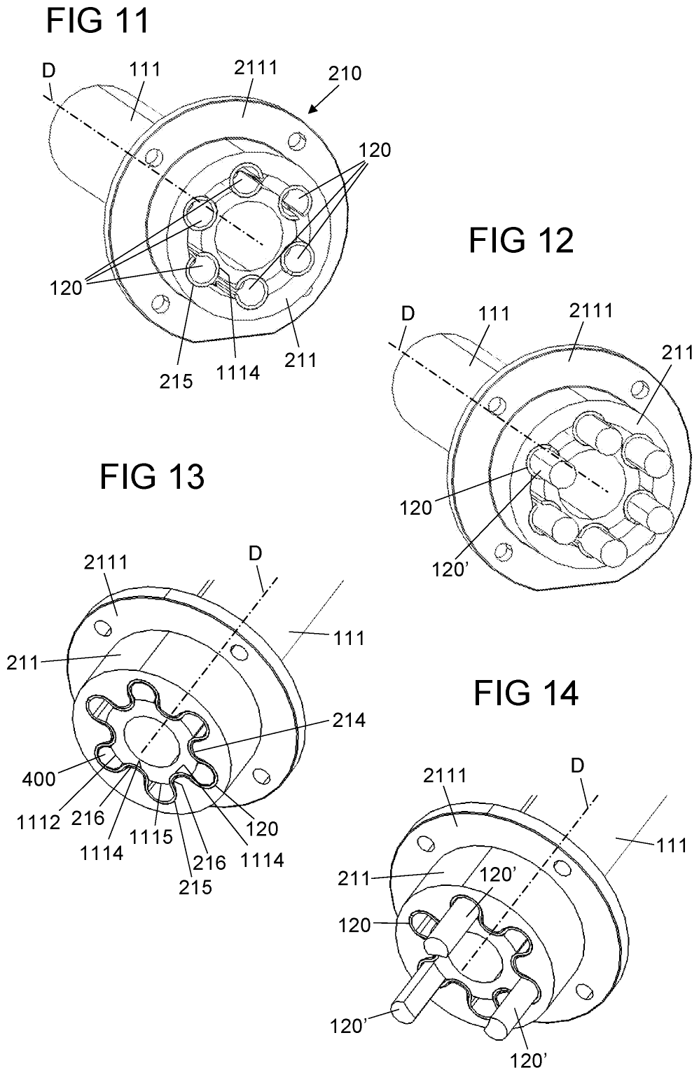

In the present case, the arrangement of elastic elements 120 comprises six spring rollers (FIGS. 9 and 11). The number can be adapted, however, in a manner which corresponds to the desired deformation behaviour, the distribution in the circumferential direction of the shaft 111 preferably taking place uniformly. In the case of the use of, for example, three spring rollers, the space (in the first and second receptacles 1114, 215) between in each case adjacent spring rollers remains free. The number of receptacles can also be adapted to the number of spring rollers.

FIG. 12 shows a further embodiment of the steer-by-wire steering system 100. Here, an illustration in accordance with FIG. 11 is selected. The embodiment of FIG. 12 differs from that of FIGS. 7 to 11, in particular, in relation to the elastic elements. The elastic elements thus have spring rollers 120, in which in each case one filling element 120′ is arranged. (For improved illustration, the filling elements 120′ are shown pulled out of the spring rollers 120 in FIG. 12.) The filling element 120′ is manufactured from an elastic material, for example rubber, and has a rod shape. The shape of the filling element is, in particular, complementary with respect to that of the spring roller. In the embodiment of FIG. 12, all the spring rollers 120 are provided with a filling element 120′. Only some of the spring rollers 120 can also be provided with a filling element, however. Here, the number of spring rollers with and without filling element should be selected in such a way that a symmetrical arrangement is possible.

FIG. 13 shows a further embodiment of the steer-by-wire steering system 100 which differs from the embodiment of FIGS. 7 to 11, in particular, in relation to the elastic elements. Here, only one elastic element 120 is thus provided which is configured as a multi-spring. The multi-spring inherently combines the deformation behaviour of the arrangement of spring rollers which is described in conjunction with FIGS. 7 to 11.

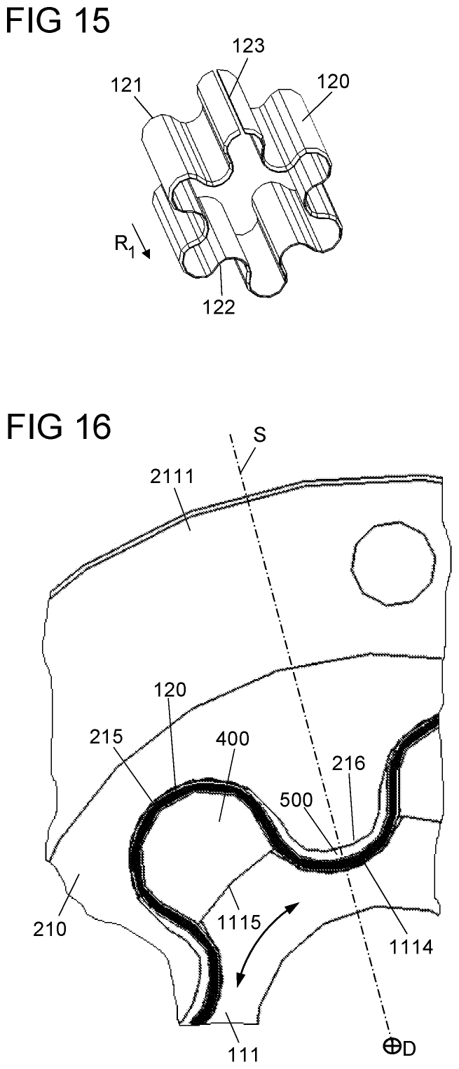

The multi-spring 120 is shown in detail in FIG. 15. The multi-spring 120 is manufactured from a material section, in particular a sheet metal section, with a defined material thickness, which material section is shaped in a meandering manner and follows a circular path in the process. The multi-spring 120 has a slot 123 which runs parallel to the longitudinal extent of the multi-spring 120 and to the rotational axis D. Here, the slot 123 extends over the entire extent of the multi-spring 120 between its first end 121 which faces the first part 211 of the bearing bush 210, and its second end 122 which faces the second part 212 of the bearing bush 210. In addition, with regard to the slot, reference is made to the comments with respect to the slot of the spring roller.

In the case of the multi-spring, the connection to the shaft 111 or to the bearing bush 210 also takes place via the engagement of the multi-spring 120 into groove-shaped recesses which form the first and second receptacles 1114, 215. Here, the first and second receptacles 1114, 215 are offset in the radial direction with respect to the rotational axis D. In particular, the first receptacles 1114 lie further to the inside than the second receptacles 215. In the circumferential direction, the first and second receptacles 1114, 215 are arranged in an offset and alternating manner.

So-called first projections 1115 of the shaft 111 lie (in the circumferential direction) between the first receptacles 1114 of the shaft 111. So-called second projections 216 of the bearing bush 210 likewise lie (in the circumferential direction) between the second receptacles 215 of the bearing bush 210. In the radial direction, in each case one first receptacle 1114 of the shaft 111 and one second projection 216 of the bearing bush 210 lie opposite one another, as do one second receptacle 215 of the bearing bush 210 and one first projection 1115 of the shaft 111. Here, the first projections 1115 of the shaft 111 do not engage completely, but rather only up to a defined depth, into the second receptacles 215 of the bearing bush 210 (and therefore into those sections of the multi-spring 120 which are arranged in the second receptacles 215). As a result of this engagement, the greatest external diameter of the shaft 111 is greater than the smallest internal diameter of the bearing bush 210. Since the engagement takes place only up to a defined depth, intermediate spaces 400 are produced, as viewed in the radial direction, between the first projections 1115 of the shaft 111 and the second receptacles 215 of the bearing bush 210 (or those sections of the multi-spring 120 which are arranged in the second receptacles 215).

FIG. 16 shows an enlarged illustration of a partial sectional view of the bearing bush 210 and the shaft 111 with the multi-spring 120 from FIG. 13. In addition, a symmetry line S is shown which, starting from the rotational axis D, extends radially and centrally through a first receptacle 1114 (symmetrical with regard to the symmetry line S) of the shaft 111 and the corresponding second projection 216 (likewise symmetrical with regard to the symmetry line S) of the bearing bush 210. The second projection 216 of the bearing bush 210 protrudes almost completely into the first receptacle 1114 of the shaft 111 (and into that section of the multi-spring 120 which is arranged in the first receptacle 1114 of the shaft 111). As a result, a comparatively small and narrow gap 500 (in comparison with the abovementioned intermediate spaces 400) is produced between the second projection 216 of the bearing bush 210 and that section of the multi-spring 120 which is arranged in the first receptacle 1114 of the shaft 111. The arrangement is shown in FIG. 16 in an unloaded state, in which no torque is exerted on the shaft 111. In this state, the gap 500 is substantially symmetrical with regard to the symmetry line S, and permits a rotation of the shaft 111 (shown in a central position) both in and counter to the clockwise direction. In the case of the introduction of a torque into the shaft 111, the shaft 111 rotates with regard to the bearing bush 210 with simultaneous deformation of the multi-spring 120 and changing of the gap 500. In particular, the gap 500 becomes narrower on that side of the symmetry line S which lies in the rotational direction, and the gap 500 thus loses its substantially symmetrical shape. If the torque reaches a defined limit value, there is no longer a gap.

The second projection 216 of the bearing bush 216 thus in regions forms a stop which limits the rotary angle of the shaft 111.

FIG. 14 shows a further embodiment of the steer-by-wire steering system 100. The embodiment of FIG. 14 differs from that of FIG. 13, in particular, in relation to the elastic element. The elastic element thus has a multi-spring 120 and (here, by way of example) three filling elements 120′ which are arranged in the intermediate spaces 400. (For improved illustration, FIG. 14 shows the filling elements 120′ pulled out of the intermediate spaces 400.) The filling element 120′ is manufactured (as mentioned in conjunction with the embodiment of FIG. 12) from an elastic material, for example rubber, and has a rod shape. In the embodiment of FIG. 14, three of six intermediate spaces 400 are provided with in each case one filling element 120′. All the intermediate spaces can also be provided with a filling element, however. The shape of the filling elements 120′ is, in particular, complementary with respect to the shape of the intermediate spaces 400.

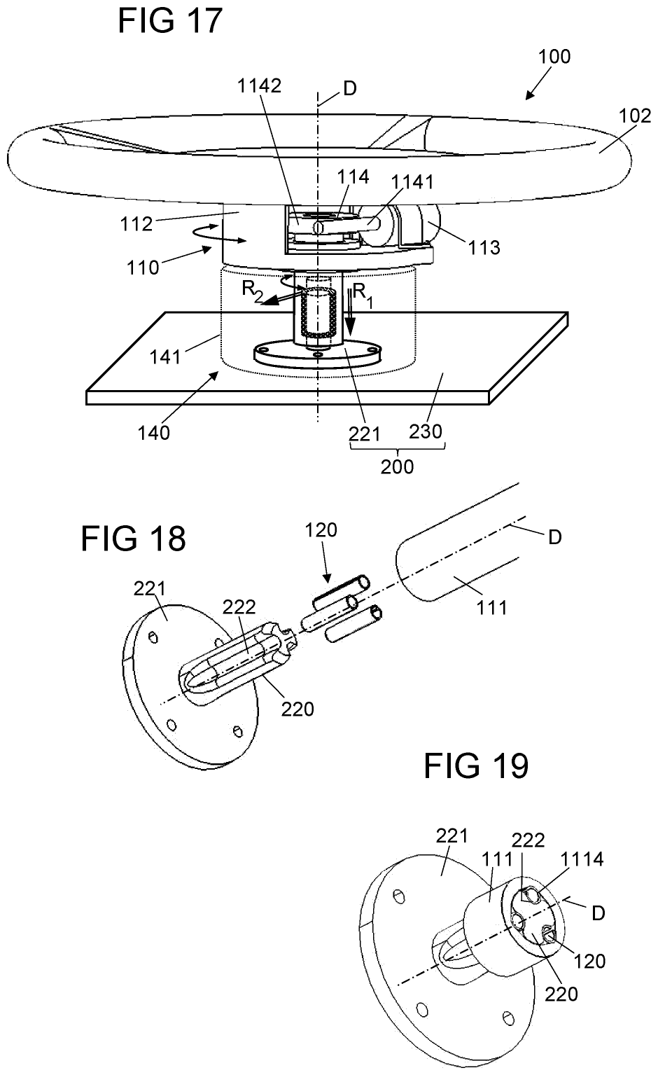

FIG. 17 shows a further embodiment of the steer-by-wire steering system 100. The embodiment of FIG. 17 differs from that of FIGS. 7 to 16, in particular, in that the shaft 111 is configured as a hollow shaft, and in that a bearing pin 220 is provided instead of a bearing bush. The bearing pin 220 is mounted at least in sections in the hollow shaft 111. The bearing pin 220 has a flange 221 which is supported on a carrier 230 of the supporting element 200 which is fixed to the vehicle, and is connected fixedly to the said carrier 230. Therefore, the bearing pin 220 is part of the supporting element 200 which is fixed to the vehicle, and forms, in particular, a section of the supporting element 200 which is fixed to the vehicle, which section extends parallel to the rotational axis D. The shaft 111 forms a section of the restoring torque generator, which section likewise extends parallel to the rotational axis D.

The elastic elements 120 which are configured here by way of example as spring rollers are arranged, as shown in the exploded illustration in FIG. 18 and the sectional illustration in FIG. 19, between the bearing pin 220 firstly and an inner shell face of the hollow shaft 111 secondly, that is to say in the interior of the hollow shaft 111. Here, the spring rollers 120 are not connected fixedly to the bearing pin 220 and the shaft 111, but are merely mounted between the bearing pin 220 and the shaft 111. In particular, the spring rollers 120 are arranged distributed along a section of an inner shell face of the shaft 111 and a section of an outer shell face of the bearing pin 220.

The spring rollers 120 extend in each case longitudinally, parallel to the rotational axis D (first direction R₁), and are distributed uniformly around the rotational axis D. They have a substantially higher stiffness in the first direction R₁ than in a direction perpendicularly with respect thereto (second and third direction R₂ and R₃). By way of example, three spring rollers 120 are provided in this embodiment. The number of spring rollers can differ from this, however.

As shown in FIG. 19, in its inner shell face, the shaft 111 has groove-shaped recesses which form first receptacles 1114 for the spring rollers 120 and run parallel to the rotational axis D, and, in its outer shell face, the bearing pin 220 has groove-shaped recesses which form second receptacles 222 for the spring rollers 120 and likewise run parallel to the rotational axis D. Starting from the rotational axis D in the radial direction, the first receptacles 1114 and the second receptacles 222 lie in each case opposite one another. The spring rollers 120 are positioned in the groove-shaped recesses of the inner shell face of the shaft 111, and engage into the corresponding groove-shaped recesses of the outer shell face of the bearing pin 220. The spring rollers 120 are thus secured against a linear movement transversely with respect to the rotational axis D.

Here, the second receptacles 222 of the bearing pin 220 do not extend by way of example as far as to the flange 221 of the bearing pin 220. An axial movement of the spring rollers 120 with respect to the bearing pin 220 in the one direction (away from the steering handle 102) is thus prevented as far as possible. As an alternative, a securing ring which is arranged on the bearing pin 220 or the flange 221 can assume this function. In order to prevent an axial movement of the spring rollers 120 with respect to the bearing pin 220 in the other direction (towards the steering handle 102), suitable stops, for example projections (cross-sectional constrictions) or additional means in the form of securing rings can be provided in the interior of the shaft.

The bearing pin 220 is connected to the shaft 111, via the elastic elements 120 which are configured as spring rollers, in such a way that the shaft 111 can be rotated with regard to the bearing pin 220, but a movement in the direction of the rotational axis D is prevented as far as possible.

With regard to the influence of the deformation behaviour of the spring rollers 120 and details, reference is made to the description of functionally identical elements of the embodiments of FIGS. 7 to 16. In the embodiment of FIGS. 17 to 19, the elastic elements are configured as spring rollers. In addition, the spring rollers can be provided (in a manner which corresponds to the embodiment from FIG. 12) with filling elements. Instead of the spring rollers, a multi-spring in accordance with the embodiments of FIGS. 13 to 16 (with or without filling elements) can also be provided.

In contrast to the embodiments of FIGS. 1 to 19, in the case of the embodiments of FIGS. 20 to 22, the at least one elastic element is formed by way of a part of the restoring torque generator and/or of the supporting element which is fixed to the vehicle.

FIG. 20 shows only one constituent part of a steer-by-wire steering system. The remaining constituent parts which are not shown here are described in conjunction with FIG. 7. Specifically, FIG. 20 shows a shaft 111 which is part of a restoring torque generator, and a bearing bush 240 which is provided for fastening to a carrier (not shown in further detail) of a supporting element which is fixed to the vehicle. The bearing bush 240 has a receiving section 241 and a flange 242, and is configured here in one piece by way of example. The receiving section 241 extends along the rotational axis D and serves to receive the shaft 111. The flange 242 adjoins (as viewed along the rotational axis D) the receiving section 241, and serves for fastening to the carrier of the supporting element which is fixed to the vehicle.

The shaft 111 is configured as a hollow shaft at least in its end region 1118 which faces away from the steering handle. By way of forming, a cross section (transversely with respect to the rotational axis D) has been stamped into the hollow shaft 1118, which cross section is not rotationally symmetrical with regard to the rotational axis D, with the result that, in the case of the application of a torque to the shaft 111, an elastic deformation of that end region 1118 of the shaft 111 which is designed as a hollow shaft is possible. Here, in the present case, the wall of the hollow shaft 1118 has by way of example two indentations 1116 which lie opposite one another. In the present case, the cross section of the hollow shaft 1118 in the end region of the shaft 111 is produced by way of forming of an original hollow cylinder with a circularly annular cross section.

The end region 1118 of the shaft 111 is mounted in the receiving section 241 of the bearing bush 240. The receiving section 241 has a shape which is complementary with respect to the end region 1118 of the shaft 111.

On its outer side which faces the receiving section 241, the wall of the hollow shaft 1118 is provided in regions with outwardly protruding projections 1117. The projections 1117 are provided to engage behind that end side of the receiving section 241 of the bearing bush 240 which faces away from the flange 242. The projections 1117 therefore form latching elements for the connection of the shaft 111 and the bearing bush 240.

In the embodiment from FIG. 20, the elastic element 120 is formed only by way of the end region 1118 of the shaft 111. As an alternative or in addition, the elastic element can also be formed by way of the bearing bush 240 which receives the end region 1118, in particular the receiving section 241 of the bearing bush 240.

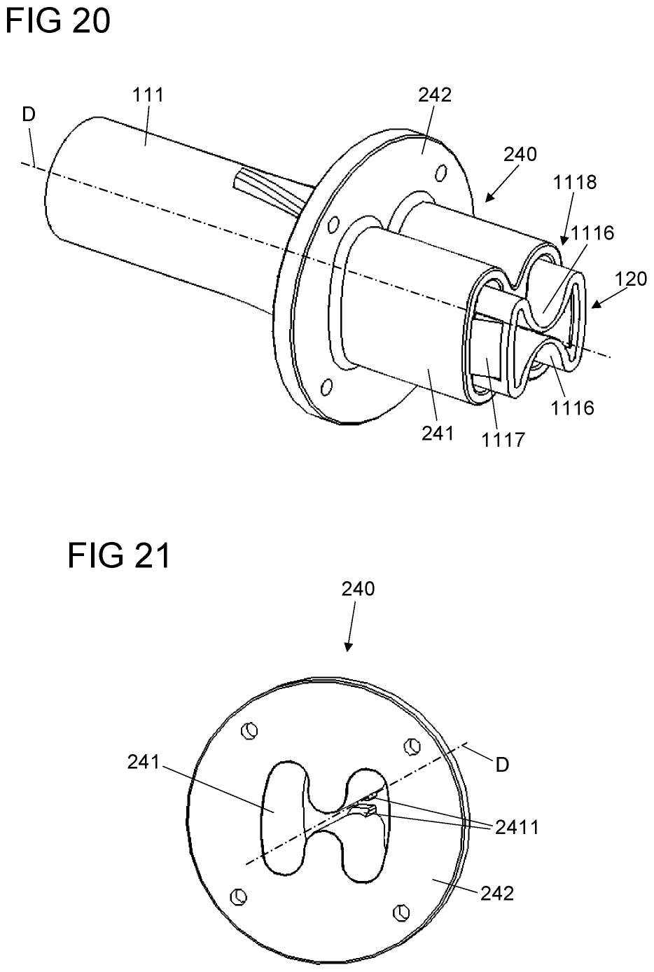

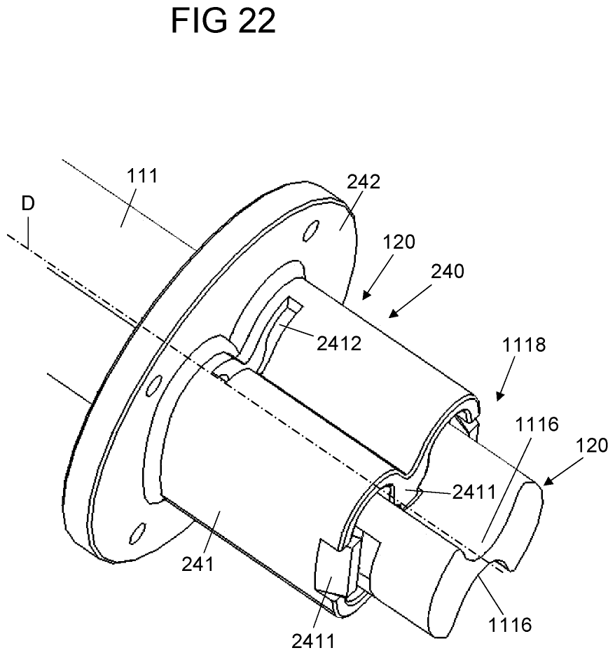

FIG. 21 shows the bearing bush 240 from FIG. 20 from a different perspective. According to FIG. 21, on its inner side which faces the hollow shaft 1118, the receiving section 241 of the bearing bush 240 has projections 2411 which are directed inwards in the direction of the hollow shaft 1118 and are provided for engagement into corresponding depressions which are configured on that outer side of the hollow shaft 1118 which faces the receiving section 241. Instead of the depressions, passage openings can also be provided. Here, the projections 2411 are configured in a region of the receiving section 241, which region is assigned to the indentations 1116 of the hollow shaft 1118. The projections 2411 form further latching elements for the connection of the shaft 111 and the bearing bush 240. Thus, firstly the shaft 111 can be configured with the projections 1117, and secondly the receiving section 241 of the bearing bush 240 can be configured with the projections 2411. As an alternative, only the receiving section 241 of the bearing bush 240 can be configured with the projections 2411, or only the shaft 111 can be configured with the projections 1117.

In the embodiment of FIG. 22, projections 2411 which form latching elements and are directed in the direction of the hollow shaft are provided on the receiving section 241 of the bearing bush 240. Furthermore, the receiving section 241 has slot-shaped regions 2412, in which the wall of the receiving section 241 is interrupted for the purpose of material weakening. In the present case, the slot-shaped regions 2412 run transversely with respect to the rotational axis D; a course parallel to the rotational axis D is also possible, however. By way of these regions 2412, the deformation behaviour of the receiving section 241 of the bearing bush 240 can be influenced (in the case of the application of a torque to the shaft), with the result that the receiving section 241 forms an elastic element 120. In this embodiment, the end region 1118 of the shaft 111 also forms an elastic element 120 on account of its shape.

The cross-sectional deformations of the shaft and the bearing bush which are described in conjunction with FIGS. 20 to 22 are to be understood to be merely exemplary. Other shapes which are not rotationally symmetrical with regard to the rotational axis D are possible.

Steer-by-wire steering systems 100 have been described, in which the restoring torque generator 110 serves to generate a torque which is directed counter to a rotation of the steering handle 102 of a motor vehicle. Applications are also conceivable, however, in the case of which a torque is generated which assists the rotation of the steering handle of a motor vehicle, or in the case of which a torque is generated without an influence of the vehicle driver.

1. A steer-by-wire steering system comprising
a steering handle which can be rotated about a rotational axis,
a restoring torque generator which is assigned to the steering handle for the generation of a torque which is directed counter to a rotation of the steering handle about the rotational axis, and
at least one elastic element, via which the restoring torque generator is supported on a supporting element which is fixed to the vehicle,
wherein the at least one elastic element has a higher stiffness in a first direction parallel to the rotational axis than in a second direction which runs substantially perpendicularly with respect to the rotational axis and, in particular, tangentially with respect to an imaginary rotational body, the axis of rotation of which coincides with the rotational axis.

2. The steer-by-wire steering system according to claim 1, wherein at least one of
the restoring torque generator is connected solely via the at least one elastic element to the supporting element which is fixed to the vehicle, and, in particular, in that the restoring torque generator does not have any connection to another element which is fixed to the vehicle, and
the restoring torque generator is supported via the at least one elastic element on the supporting element which is fixed to the vehicle, counter to a rotation about the rotational axis of the steering handle.

3. The steer-by-wire steering system according to claim 1, wherein the restoring torque generator comprises:
a housing,
a drive which is arranged in a stationary manner in the housing,
a transmission which is in engagement with the drive, and
a shaft which is mounted in the housing and is connected in a rotationally fixed manner to a component of the transmission,
wherein the shaft or the housing being configured for a rotationally fixed connection to the steering handle, and the housing, the transmission and the shaft being configured for a bearing arrangement which is rotatable in relation to the motor vehicle and about a rotational axis of the shaft.

4. The steer-by-wire steering system according to claim 3, wherein
the housing is configured for a rotationally fixed connection to the steering handle, and in that the at least one elastic element is connected in a rotationally fixed manner via a first end to the shaft, in particular to a first end of the shaft, which first end faces away from the steering handle, and is fastened via a second end to the supporting element which is fixed to the vehicle, or
the shaft is configured for a rotationally fixed connection to the steering handle, and the at least one elastic element is connected in a rotationally fixed manner via a first end to the housing, and is fastened via a second end to the supporting element which is fixed to the vehicle.

5. The steer-by-wire steering system according to claim 1, wherein a plurality of elastic elements are provided.

6. The steer-by-wire steering system according to claim 5, wherein the elastic elements
are arranged in one plane which extends perpendicularly with respect to the rotational axis, or
are arranged in a plurality of planes which extend in each case perpendicularly with respect to the rotational axis, a plurality of elastic elements being arranged in at least one of the plurality of planes.

7. The steer-by-wire steering system according to claim 5, wherein the elastic elements are arranged one after another along the rotational axis.

8. The steer-by-wire steering system according to claim 5, wherein at least one of
the elastic elements which are not arranged in one plane which extends perpendicularly with respect to the rotational axis have different radial orientations, and
the elastic elements have different dimensions.

9. The steer-by-wire steering system according to claim 1, wherein the at least one elastic element is configured as a leaf spring.

10. The steer-by-wire steering system according to claim 1, wherein the at least one elastic element has a greater extent in the first direction parallel to the rotational axis than in the second direction which runs substantially perpendicularly with respect to the rotational axis and, in particular, tangentially with respect to the imaginary rotational body, the axis of rotation of which coincides with the rotational axis.

11. The steer-by-wire steering system according to claim 1, wherein the at least one elastic element has a greater extent in the first direction parallel to the rotational axis than in a third direction which runs substantially radially with respect to the rotational axis.

12. The steer-by-wire steering system according to claim 1, wherein, as viewed radially with respect to the rotational axis, the at least one elastic element is arranged between firstly a section of the restoring torque generator, which section extends parallel to the rotational axis, and secondly a section, which extends parallel to the rotational axis, of the supporting element which is fixed to the vehicle or of an element which is connected fixedly to the supporting element which is fixed to the vehicle.

13. The steer-by-wire steering system according to claim 12, wherein, in order to secure the at least one elastic element, the section of the restoring torque generator has at least one first receptacle, and the section of the supporting element which is fixed to the vehicle or of the element which is connected to the said supporting element has at least one second receptacle.

14. The steer-by-wire steering system according to claim 1, wherein a plurality of elastic elements are provided which in each case comprise a spring roller which is, in particular, tubular and has a slot which is, in particular, continuous and extends along the rotational axis.

15. The steer-by-wire steering system according to claim 13, wherein a plurality of elastic elements are provided which in each case comprise a spring roller which is, in particular, tubular and has a slot which is, in particular, continuous and extends along the rotational axis, wherein the at least one first receptacle and the at least one second receptacle which are assigned to one of the plurality of elastic elements are arranged radially in relation to the rotational axis.

16. The steer-by-wire steering system according to claim 1, wherein the at least one elastic element has a multi-spring which extends virtually completely about the rotational axis in the circumferential direction and has a slot which is, in particular, continuous and extends along the rotational axis, the multi-spring being formed in such a way that its radial spacing from the rotational axis increases and decreases in the circumferential direction in an alternating manner.

17. The steer-by-wire steering system according to claim 13, wherein the at least one elastic element has a multi-spring which extends virtually completely about the rotational axis in the circumferential direction and has a slot which is, in particular, continuous and extends along the rotational axis, the multi-spring being formed in such a way that its radial spacing from the rotational axis increases and decreases in the circumferential direction in an alternating manner, wherein the at least one first receptacle and the at least one second receptacle are arranged offset with respect to one another in the circumferential direction and in an alternating manner around the rotational axis.

18. The steer-by-wire steering system according to claim 1, wherein the at least one elastic element is an integral constituent part of the restoring torque generator and/or of the supporting element which is fixed to the vehicle.

19. The steer-by-wire steering system according to claim 18, wherein the restoring torque generator comprises a shaft, and the supporting element which is fixed to the vehicle comprises a bearing bush, the bearing bush being provided and being configured for supporting the shaft, and the at least one elastic element being formed by way of a section of the shaft and/or by way of a section of the bearing bush.

20. The steer-by-wire steering system according to claim 19, wherein at least one of
the section of the shaft which forms the at least one elastic element is configured as a hollow shaft, the cross-sectional shape of which transversely with respect to the rotational axis is such that, in the case of application of a torque to the shaft, it permits an elastic deformation of the section of the shaft, and/or in that that section of the bearing bush which forms the at least one elastic element has a cross-sectional shape transversely with respect to the rotational axis which, in the case of application of a torque to the shaft, permits an elastic deformation of the section of the bearing bush, and
that section of the shaft or that section of the bearing bush which forms the at least one elastic element has at least one region with a reduced material thickness, and
the shaft and the bearing bush are connected to one another, in particular by way of a latching connection.
